(19) United States
(12) Patent Application Publication
(10) Pub. No.: US 2024/0394520 A1
(43) Pub. Date: Nov. 28, 2024

(54) NEURAL NETWORK SYSTEM, LEARNING DEVICE, AND LEARNING METHOD

(71) Applicant: NEC Corporation, Tokyo (JP)

(72) Inventor: Yusuke SAKEMI, Narashino-shi (JP)

(73) Assignee: NEC Corporation, Tokyo (JP)

(21) Appl. No.: 18/669,710

(22) Filed: May 21, 2024

(30) Foreign Application Priority Data
May 22, 2023 (JP) 2023-083976

(51) Int. Cl. G06N 3/049; G06N 3/084

(52) U.S. Cl. CPC G06N 3/049; G06N 3/084

(57) ABSTRACT

A neural network system includes a time-based spiking neural network configured using a neuron model based on an integrate-and-fire model, and trains the spiking neural network using an evaluation function that indicates a better evaluation as a probability that an individual neuron model fires decreases.

This application is based upon and claims the benefit of priority from Japanese patent application No. 2023-083976, filed on May 22, 2023, the disclosure of which is incorporated herein in its entirety by reference.

### TECHNICAL FIELD

The present disclosure relates to a neural network system, a learning device, and a learning method.

### BACKGROUND ART

A spiking neural network (SNN) is one example of a neural network (for example, see Published Japanese translation No. 2017-509953 of PCT International Publication).

### SUMMARY

It is preferable that the power consumption when a spiking neural network operates is as low as possible.

An exemplary object of the present disclosure is to provide a neural network system, a learning device, a learning method, and a program that are capable of solving the above problem.

According to a first exemplary aspect of the present disclosure, a neural network system includes: a time-based spiking neural network configured using a neuron model based on an integrate-and-fire model; and trains the spiking neural network using an evaluation function that indicates a better evaluation as a probability that an individual neuron model fires decreases.

According to a second exemplary aspect of the present disclosure, a learning device trains a spiking neural network, being a time-based spiking neural network configured using a neuron model based on an integrate-and-fire model, using an evaluation function that indicates a better evaluation as a probability that an individual neuron model fires decreases.

According to a third exemplary aspect of the present disclosure, a learning method executed by a computer, the learning method includes: training a spiking neural network, being a time-based spiking neural network configured using a neuron model based on an integrate-and-fire model, using an evaluation function that indicates a better evaluation as a probability that an individual neuron model fires decreases.

According to a fourth exemplary aspect of the present disclosure, a non-transitory storage medium storing a program causes a computer to execute the step of: training a spiking neural network, being a time-based spiking neural network configured using a neuron model based on an integrate-and-fire model, using an evaluation function that indicates a better evaluation as a probability that an individual neuron model fires decreases.

According to the present disclosure, it is expected that the power consumption when a spiking neural network operates will be relatively low.

### BRIEF DESCRIPTION OF THE DRAWINGS

FIG. 1 is a diagram showing an example of a configuration of a neural network system according to an exemplary embodiment.

FIG. 2 is a diagram showing an example of time integration relating to a membrane potential in an exemplary embodiment.

FIG. 3 is a diagram showing an example of a firing condition of a neuron model in an exemplary embodiment.

FIG. 4 is a diagram showing a neuron model firing state observed when γ₂=0 in an experiment relating to an exemplary embodiment.

FIG. 5 is a diagram showing a neuron model firing state observed when γ₂=2.3×10⁻⁷ in an experiment relating to an exemplary embodiment.

FIG. 6 is a diagram showing a neuron model firing state observed when γ₂=4.8×10⁻⁶ in an experiment relating to an exemplary embodiment.

FIG. 7 is a diagram showing a first example of a relationship between the recognition rate of a neural network and the firing proportion of neuron models in an intermediate layer in an exemplary embodiment.

FIG. 8 is a diagram showing a second example of a relationship between the recognition rate of a neural network and the firing proportion of neuron models in intermediate layers in an exemplary embodiment.

FIG. 9 is a diagram showing a third example of a relationship between the recognition rate of a neural network and the firing proportion of neuron models in an intermediate layer in an exemplary embodiment.

FIG. 10 is a diagram showing a fourth example of a relationship between the recognition rate of a neural network and the firing proportion of neuron models in intermediate layers in an exemplary embodiment.

FIG. 11 is a diagram showing an example of a configuration of a neural network system according to an exemplary embodiment.

FIG. 12 is a diagram showing an example of a configuration of a learning device according to an exemplary embodiment.

FIG. 13 is a diagram showing an example of a processing procedure of a learning method according to an exemplary embodiment.

FIG. 14 is a diagram showing a configuration of a computer according to at least one exemplary embodiment.

### EXAMPLE EMBODIMENT

Hereunder, an exemplary embodiment of the present embodiment will be described. However, the following exemplary embodiment does not limit the disclosure according to the claims. Furthermore, not all combinations of features described in the exemplary embodiment are essential to the solution means of the disclosure.

In the following, a character with a circumflex is sometimes represented by adding ∧ after the character. For example, v with a circumflex is also written as v∧.

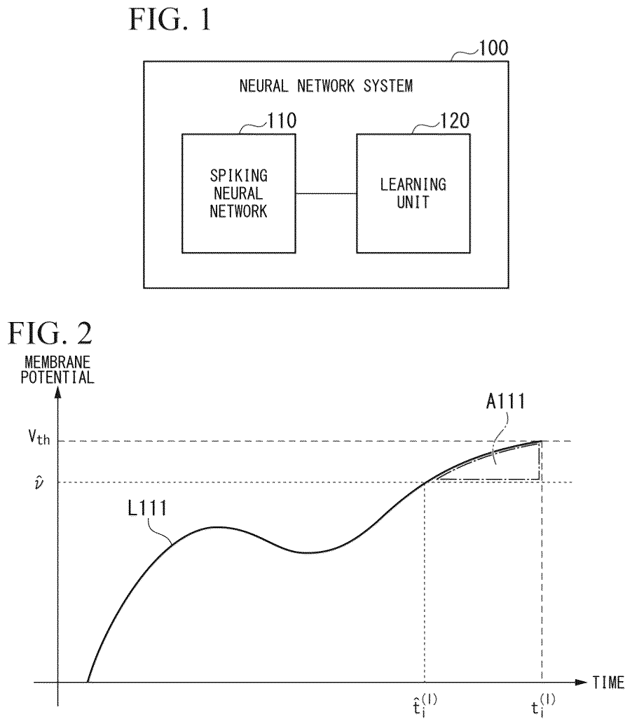

FIG. 1 is a diagram showing an example of a configuration of a neural network system according to an exemplary embodiment. In the configuration shown in FIG. 1, the neural network system 100 includes a spiking neural network 110 and a learning unit 120.

The neural network system 100 is a system that trains the spiking neural network 110. The neural network system 100 may be configured as a single device, or may be configured by combining a plurality of devices. For example, the spiking neural network 110 may be configured using hardware including an analog circuit, and the learning unit 120 may be configured using a computer such as a personal computer (PC).

The spiking neural network 110 is a time-based spiking neural network that is configured using neuron models (spiking neuron models) based on an integrate-and-fire (IF) model.

The spiking neural network referred to here is a neural network in which neuron models output signals at timings based on a state quantity referred to as a membrane potential, which changes over time depending on the input state of the signals to the neuron models themselves. The signals input and output by the neuron models are also referred to as spike signals, or simply spikes. The output of a spike by a neuron model is also referred to as firing.

The spiking neural network 110 uses a time method that transmits information using the transmission timings of spike signals (firing times of the neuron models) as the information transmission method between the neuron models.

In an integrate-and-fire model, the membrane potential changes in response to an input spike to the neuron model, and the neuron model fires when the membrane potential reaches a threshold. The threshold used to determine the firing timing of the neuron model is also referred to as a threshold membrane potential, or a firing threshold.

The processing performed by the spiking neural network 110 can be the various processing that can be executed using a spiking neural network. For example, the spiking neural network 110 may perform image recognition, voice recognition, biometric authentication, or numerical prediction, but is not limited to these.

The learning unit 120 trains the spiking neural network 110. Specifically, the learning unit 120 updates parameter values such as the weighting coefficients of the input spikes to each neuron model of the spiking neural network 110. In particular, the learning unit 120 trains the spiking neural network 110 using an evaluation function that indicates a better evaluation as the probability of the individual neuron models of the spiking neural network 110 firing decreases. Furthermore, the learning unit 120 trains the spiking neural network 110 using a learning method that uses differentiation of the evaluation function, such as error backpropagation.

The learning unit 120 corresponds to an example of a learning means.

Here, it is thought that the neuron models consume power when firing, such as when the neuron models output voltage pulses as spikes. It is expected that the power consumption of the spiking neural network 110 will decrease as the number of times the neuron models fire decreases (as the firing frequency decreases).

Therefore, as a result of the learning unit 120 training the spiking neural network 110 using an evaluation function that indicates a better evaluation as the probability of the neuron models firing decreases, it is expected that the number of times the neuron models fire will become relatively low, and the power consumption of the spiking neural network 110 will be relatively low.

In the following, a case where the learning unit 120 trains the spiking neural network 110 using a loss function (cost function) as the evaluation function will be described as an example. The loss function referred to here is a function in which a smaller function value indicates a better evaluation. However, the learning unit 120 may use, as the evaluation function, a function in which a larger function value indicates a better evaluation.

For example, the learning unit 120 trains the spiking neural network 110 using the loss function C shown in expression (1).

$$C = {\sum }_{p} {κ}_{p} ln {S}_{p} + {γ}_{2} V + {γ}_{3} Q \qquad ( 1 )$$

ΣₚκₚInSₚ is a term for increasing the accuracy of estimation by the neural network. Expression (1) shows an example where the neural network performs class classification. A term for increasing the accuracy of estimation by the neural network is also referred to as an estimation loss term. p represents the identification number of a class. Furthermore, in the example of expression (1), the spiking neural network 110 has the same number of output nodes as classes, and the classes and output nodes are assumed to be in a one-to-one correspondence. p is also used as an identification number of an output node.

κₚ represents a teacher label. κₚ=1 for the correct class, and κₚ=0 for all other classes.

In represents the natural logarithm.

Sₚ is a Softmax function used for the pth class, and is expressed as in expression (2).

$${S}_{p} = \frac{exp ( - \frac{{t}_{p}}{{σ}_{soft}} )}{{\sum }_{q} exp ( - \frac{{t}_{q}}{{σ}_{soft}} )} \qquad ( 2 )$$

exp represents the power of Napier's number e.

Similarly to p, q represents the identification number of a class.

tₚ represents the firing time of the pth output node.

σ_{soft} is a constant provided as a scale factor for adjusting the degree of change in the value of the Softmax function Sₚ when the firing time of the output layer changes, with σ_{soft}>0.

However, the estimation loss term used by the learning unit 120 is not limited to being a specific term. For example, the learning unit 120 may use a loss function in which a function other than a Softmax function is used for the estimation loss term. γ₂V and γ₃Q in expression (1) each correspond to an example of a term that indicates a better evaluation as a probability that an individual neuron model fires decreases.

The sub-expression V is a sub-expression for evaluating the probability that a neuron model will fire based on a time integral of the membrane potential. The value of the sub-expression V is also referred to as a time-integrated loss of the membrane potential. However, as will be described later, the value of sub-expression V can be calculated without the need to acquire the value of the membrane potential.

γ₂ is a coefficient for adjusting the degree of influence of the value of the sub-expression V on the value of the loss function C. The coefficient γ₂ corresponds to an example of a coefficient for adjusting the degree of influence of a sub-expression that indicates a better evaluation as a probability that an individual neuron model fires decreases.

For example, the value of the coefficient γ₂ may be set in advance by the user.

The time-integrated loss term γ₂V of the membrane potential can be regarded as a type of regularization term. The regularization term referred to here is a term that is provided so that the values of the weighting coefficients of the neural network become relatively small.

The time-integrated loss term γ₂V of the membrane potential, or regularization using the time-integrated loss term γ₂V of the membrane potential is also referred to as M-SSR (Membrane potential-based Spike timing-based Sparse-firing Regularization).

The sub-expression Q is a sub-expression for evaluating the probability that a neuron model will fire based on a firing condition. The value of the sub-expression Q is also referred to as a loss relating to a firing condition.

γ₃ is a coefficient for adjusting the degree of influence of the value of the sub-expression Q on the value of the loss function C. The coefficient γ₃ corresponds to an example of a coefficient for adjusting the degree of influence of a sub-expression that indicates a better evaluation as a probability that an individual neuron model fires decreases.

For example, the value of the coefficient γ₃ may be set in advance by the user.

The loss term γ₃Q relating to a firing condition can be regarded as a type of regularization term.

The loss term γ₃Q relating to a firing condition or regularization using the loss term γ₃Q relating to a firing condition, is also referred to as F-SSR (firing-condition-based SSR).

However, the loss function used by the learning unit 120 is not limited to the function shown in expression (1). Of the terms γ₂V and γ₃Q, the learning unit 120 may use a loss function that includes only the term γ₂V, or may use a loss function that includes only the term γ₃Q. Furthermore, the learning unit 120 may use a loss function including a term other than a time-integrated loss term of the membrane potential or a loss term relating to a firing condition, as a term that indicates a better evaluation as a probability that an individual neuron model fires decreases.

### (Time-Integrated Loss of Membrane Potential)

The sub-expression V is expressed as in expression (3).

$$V = {\sum }_{l} {player}^{( l )} {\sum }_{i} {V}_{i}^{( l )} \qquad ( 3 )$$

l represents the identification number of a layer of the neural network.

i represents the identification number of a neuron model included in the lth layer.

player^{(l)} is a constant for adjusting the degree of influence of the state of the lth layer, with player^{(l)}>0. For example, the value of player^{(l)} may be set in advance by the user.

V of is expressed as in expression (4).

$${V}_{i}^{( l )} = \frac{1}{{V}_{th} - \hat{v}} {\int }_{0}^{T} ( {ν}_{i}^{( l )} ( t ) - \hat{v} ) θ ( {ν}_{i}^{( l )} ( t ) - \hat{v} ) θ ( {t}_{i}^{( l )} - t ) dt \qquad ( 4 )$$

Here, Vth represents the threshold membrane potential. When the membrane potential of a neuron model reaches the threshold membrane potential Vth, the neuron model fires. v∧ is a constant such that 0<v∧<Vₜₕ. The value of v∧ corresponds to an example of a set value relating to the membrane potential.

The time interval [0, T] is a time interval relating to the firing of the neuron model. Each neuron model fires at most once during the time interval [0, T]. T is a constant such that T>0.

v^{(l)}ᵢ(t) represents the membrane potential of the ith neuron model in the lth layer at time t.

θ represents a step function. When t≥0, θ(t)=1, and when t<0, θ(t)=0.

If the ith neuron model in the lth layer does not fire by time T, then V^{(l)}ᵢ=0.

FIG. 2 is a diagram showing an example of time integration relating to a membrane potential. The horizontal axis of the graph in FIG. 2 represents time, and the vertical axis represents the membrane potential.

The line L111 represents the membrane potential v^{(l)}ᵢ(t) of the ith neuron model in the lth layer.

The time t∧^{(l)}; represents the time at which the value of the membrane potential v^{(l)}ᵢ(t) reaches the constant v∧. When the value of the membrane potential v^{(l)}ᵢ(t) increases or decreases and reaches the constant v∧ a plurality of times, the time t∧^{(l)}ᵢ represents the time at which the value of the membrane potential v^{(l)}ᵢ(t) first reached the constant v∧.

The region A111 is a region where the value of the membrane potential v^{(l)}ᵢ(t) represented by the line L111 is greater than or equal to the value of the constant v∧.

The integral ∫₀^{T} Σᵢ(v^{(l)}ᵢ(t)−v∧)θ(v^{(l)}ᵢ(t)−v∧)θ(t^{(l)}ᵢ−t) dt shown in expression (4) represents the integral of the value v^{(l)}ᵢ(t)−v∧ obtained by subtracting the constant v∧ from the membrane potential v^{(l)}ᵢ(t) when the value of the membrane potential v^{(l)}ᵢ(t) is greater than or equal to the constant v∧, such as in the area of the region A111 in FIG. 2.

When the value of the membrane potential v^{(l)}ᵢ(t) is greater than or equal to the value of the constant v∧, the value of the membrane potential v^{(l)}ᵢ(t) can be interpreted as being relatively close to the value of the threshold membrane potential Vₜₕ, and the probability of the neuron model firing can be evaluated to be relatively high. As the value of the integral shown in expression (4), which is illustrated by the area of the region A111, increases, the time during which the value of the membrane potential v^{(l)}ᵢ(t) is greater than or equal to the value of the constant v∧ can be interpreted to be longer, or the value of the membrane potential v^{(l)}ᵢ(t) can be interpreted to have become closer to the value of the threshold membrane potential Vₜₕ, or both. Therefore, as the value of the integral shown in expression (4) increases, the probability of the neuron model firing can be evaluated to be higher.

The sub-expression V^{(l)}ᵢ corresponds to an example of a sub-expression that indicates a better evaluation as the value of the time integral relating to the membrane potential v^{(l)}ᵢ(t) of a neuron model decreases.

Here, as the value of the constant v∧ approaches the value of the membrane potential v^{(l)}ᵢ(t), the value of the integral represented by expression (4) decreases. Therefore, in expression (4), in order to appropriately evaluate the probability of the neuron model firing, even when the value of the constant v∧ is close to the membrane potential v^{(l)}ᵢ(t), the value of the integral is divided by the value of (Vₜₕ−v∧).

The sub-expression V^{(l)}ᵢ corresponds to an example of a sub-expression representing, for a neuron model that has fired, a total value obtained by dividing an integral of the difference between the membrane potential v^{(l)}ᵢ(t) and the constant v∧ during the time the membrane potential v^{(l)}ᵢ(t) of the neuron model is greater than or equal to the constant v∧ and less than or equal to the threshold membrane potential Vₜₕ, by the difference between the threshold membrane potential Vₜₕ and the constant v∧. The value of the constant v∧ corresponds to an example of a set value that is a smaller value than the threshold membrane potential Vₜₕ.

The calculation of expression (4) requires the value of the membrane potential v^{(l)}ᵢ(t). When the value of the membrane potential is represented by an analog value such as a current value or a voltage value, a mechanism that measures the value of the membrane potential of each neuron model is required, which places a large burden on the hardware configuration.

Therefore, a technique that enables the value of the sub-expression V^{(l)}ᵢ to be calculated without the need to acquire the value of the membrane potential v^{(l)}ᵢ(t) will be considered.

First, the expressions are simplified by taking the limit v∧→Vₜₕ, which brings the value of the constant v∧ close to the value of the threshold membrane potential Vₜₕ. In particular, by bringing the value of the constant v∧ sufficiently close to the value of the threshold membrane potential Vₜₕ, the spikes input to the ith neuron model in the lth layer by the firing time t^{(l)}ᵢ of the neuron model are input to the neuron model before the time at which the membrane potential v^{(l)}ᵢ(t) reaches the constant v∧.

The loss function C in this case corresponds to an example of an evaluation function that takes a limit to bring the value of the constant v∧ close to the value of the threshold membrane potential Vₜₕ.

In this case, there are no spikes input to the neuron model during the time interval [t∧^{(l)}ᵢ, t^{(l)}ᵢ], and during this time interval, the membrane potential v^{(l)}ᵢ(t) can be considered to be monotonically increasing or monotonically decreasing. In particular, when the neuron model fires, because v∧<Vₜₕ, the membrane potential v^{(l)}ᵢ(t) monotonically increases.

In this way, when the membrane potential v^{(l)}ᵢ(t) monotonically increases, expression (4) can be transformed into expression (5).

$${V}_{i}^{( l )} = \frac{1}{{V}_{t h} - \hat{v}} {\int }_{{\hat{t}}_{i}^{( l )}}^{{t}_{i}^{( l )}} ( {v}_{i}^{( l )} ( t ) - \hat{ν} ) dt \qquad ( 5 )$$

Because the sub-expression v∧(t^{(l)}ᵢ−t∧^{(l)}ᵢ) that appears in the calculation of the integral shown in expression (5) becomes a constant, and is not involved in the learning, the sub-expression can be ignored.

Therefore, expression (5) is replaced with expression (6).

$${V}_{i}^{( l )} = \frac{1}{{V}_{t h} - \hat{v}} {\int }_{{\hat{t}}_{i}^{( l )}}^{{t}_{i}^{( l )}} {v}_{i}^{( l )} ( t ) dt \qquad ( 6 )$$

The membrane potential v^{(l)}ᵢ(t) can be represented by an expression using weighting coefficients w^{(l)}ᵢⱼ, firing times t^{(l-1)}ⱼ of the neuron models in the previous layer, and the like, according to the type of neuron model (the type of spiking neuron). As a result, expression (6) can be transformed into an expression in which the membrane potential v^{(l)}ᵢ(t) does not explicitly appear.

Hereunder, examples of expressions representing the sub-expression V^{(l)}ᵢ will be shown for each of the following cases, when τᵥ=∞ and τₗ=∞, when τᵥ=∞ and τₗ=τ, and when τᵥ=2τₗ=2τ, where τᵥ represents the time constant of the membrane potential, τₗ represents the time constant of the input current, and r is a constant such that τ>0. For example, the value of τᵥ may be set in advance by the user.

However, expression (6) can be applied not only to a neuron model in these cases, but also to various spiking neurons based on an integrate-and-fire model.

(When τᵥ=∞ and τₗ=∞)

When τᵥ=∞ and τₗ=∞, the membrane potential v^{(l)}ᵢ of the ith neuron model in the lth layer is expressed as in expression (7).

$${v}_{i}^{( l )} ( t ) = {\sum }_{j = 1}^{{N}^{( l - 1 )}} {w}_{ij}^{( l )} ( t - {t}_{j}^{( l - 1 )} ) θ ( t - {t}_{j}^{( l - 1 )} ) \qquad ( 7 )$$

j represents the identification number of a neuron model included in the (1-1)th layer.

N^{(l-1)} represents the number of neuron models included in the (1-1)th layer.

w^{(l)}ᵢⱼ represents the weighting coefficient of a signal from the jth neuron model in the (1-1)th layer to the ith neuron model in the lth layer.

The firing time t^{(l)}ᵢ is expressed as in expression (8).

$${t}_{i}^{( i )} = \frac{{V}_{th} + {\sum }_{j ∈ {Γ}_{i}^{( l )}} {w}_{i j}^{( l )} {t}_{j}^{( l )}}{{\sum }_{j ∈ {Γ}_{i}^{( l )}} {w}_{i j}^{( l )}} \qquad ( 8 )$$

Γ^{(l)}ᵢ represents the set of identification numbers of the neuron models among the neuron models included in the (1-1)th layer that have output spikes before the ith neuron model in the lth layer fires.

The time t∧^{(l)}ᵢ at which the membrane potential v(l); reaches the constant v∧ is expressed as in expression (9).

$${\hat{t}}_{i}^{( l )} = \frac{\hat{v} + {\sum }_{j ∈ {Γ}_{i}^{( l )}} {w}_{i j}^{( l )} {t}_{j}^{( l )}}{{\sum }_{j ∈ {Γ}_{i}^{( l )}} {w}_{i j}^{( l )}} \qquad ( 9 )$$

From expressions (8) and (9), t^{(l)}ᵢ−t∧^{(l)}ᵢ is expressed as in expression (10).

$${t}_{i}^{( i )} - {\hat{t}}_{i}^{( l )} = \frac{{V}_{th} - \hat{v}}{{\sum }_{j ∈ {Γ}_{i}^{( l )}} {w}_{i j}^{( l )}} \qquad ( 10 )$$

Expression (6) can be transformed as in expression (11).

$${V}_{i}^{( l )} = \frac{1}{{V}_{t h} - \hat{v}} {\int }_{{\hat{t}}_{i}^{( l )}}^{{t}_{i}^{( l )}} {v}_{i}^{( l )} ( t ) dt = \frac{1}{{V}_{t h} - \hat{v}} {\int }_{{\hat{t}}_{i}^{( l )}}^{{t}_{i}^{( l )}} {\sum }_{j ∈ {Γ}_{ì}^{( l )}} {w}_{i j}^{( l )} ( t - {t}_{j}^{( l - 1 )} ) dt = {\frac{1}{{V}_{t h} - \hat{v}} [ \frac{1}{2} {\sum }_{j ∈ {Γ}_{ì}^{( l )}} {{w}_{i j}^{( l )} ( t - {t}_{j}^{( l - 1 )} )}^{2} ]}_{{\hat{t}}_{i}^{( l )}}^{{t}_{i}^{( l )}} = \frac{1}{2 ( {V}_{t h} - \hat{v} )} {\sum }_{j ∈ {Γ}_{ì}^{( l )}} {w}_{i j}^{( l )} [ {( {t}_{i}^{( l )} - {t}_{j}^{( l - 1 )} )}^{2} - {( {\hat{t}}_{i}^{( l )} - {t}_{j}^{( l - 1 )} )}^{2} ] = \frac{1}{2 ( {V}_{t h} - \hat{v} )} {\sum }_{j ∈ {Γ}_{ì}^{( l )}} {w}_{i j}^{( l )} [ ( {t}_{i}^{( l )} - {\hat{t}}_{i}^{( l )} ) ( {t}_{i}^{( l )} - {\hat{t}}_{i}^{( l )} - 2 {t}_{j}^{( l - 1 )} ) ] = \frac{1}{2} {\sum }_{j ∈ {Γ}_{ì}^{( l )}} {w}_{i j}^{( l )} \frac{{t}_{i}^{( l )} - {t}_{j}^{( l - 1 )}}{{V}_{t h} - \hat{v}} ( {t}_{i}^{( l )} + {\hat{t}}_{i}^{( l )} - 2 {t}_{j}^{( l - 1 )} ) \qquad ( 11 )$$

Expression (11) can be transformed as in expression (12) using expression (10).

$${V}_{i}^{( l )} = \frac{{V}_{t h} - \hat{v}}{{\sum }_{j ∈ {Γ}_{i}^{( l )}} {w}_{ij}^{( l )}} [ \frac{1}{2} {\sum }_{j ∈ {Γ}_{ì}^{( l )}} {w}_{ij}^{( l )} \frac{1}{{V}_{t h} - \hat{v}} ( {t}_{i}^{( l )} + {\hat{t}}_{i}^{( l )} - 2 {t}_{j}^{( l - 1 )} ) ] = \frac{1}{{\sum }_{j ∈ {Γ}_{i}^{( l )}} {w}_{ij}^{( l )}} [ \frac{1}{2} {\sum }_{j ∈ {Γ}_{ì}^{( l )}} {w}_{i j}^{( l )} ( {t}_{i}^{( l )} + {\hat{t}}_{i}^{( l )} - 2 {t}_{j}^{( l - 1 )} ) ] = \frac{1}{{\sum }_{j ∈ {Γ}_{i}^{( l )}} {w}_{ij}^{( l )}} [ \frac{{t}_{í}^{( l )} + {\hat{t}}_{i}^{( 1 )}}{2} {\sum }_{j ∈ {Γ}_{i}^{( l )}} {w}_{ij}^{( l )} - {\sum }_{j ∈ {Γ}_{i}^{( l )}} {w}_{ij}^{( l )} {t}_{j}^{( l - 1 )} ] \qquad ( 12 )$$

If the value of the constant v∧ is brought sufficiently close to the threshold value Vₜₕ, and it is assumed that t∧^{(l)}ᵢ=t^{(l)}ᵢ, expression (12) can be transformed into expression (13).

$${V}_{i}^{( l )} = \frac{1}{{\sum }_{j ∈ {Γ}_{i}^{( l )}} {w}_{ij}^{( l )}} [ {t}_{i}^{( l )} {{\sum }_{j ∈ {Γ}_{i}^{( l )}}}_{} {w}_{ij}^{( l )} - {\sum }_{j ∈ {Γ}_{i}^{( l )}} {w}_{ij}^{( l )} {t}_{j}^{( l - 1 )} ] \qquad ( 13 )$$

In expression (13), the sub-expression V^{(l)}ᵢ is an expression in which the membrane potential v^{(l)}ᵢ(t) does not explicitly appear. Therefore, according to expression (13), the learning unit 120 can calculate the time-integrated loss of the membrane potential without the need to acquire the value of the membrane potential v^{(l)}ᵢ(t). This eliminates the need to provide a mechanism that measures the value of the membrane potential for each neuron model, even when the value of the membrane potential is represented by an analog value such as a current value or a voltage value. According to the neural network system 100, in this respect, the burden on the hardware configuration can be relatively reduced.

Here, in expression (7), the membrane potential v^{(l)}ᵢ(t) is expressed using the weighting coefficients w^{(l)}ᵢⱼ of the spikes input to the ith neuron model in the lth layer, and the firing times of the neuron models that output the spikes to the neuron model.

The sub-expression V^{(l)}ᵢ in expression (13) corresponds to an example of a sub-expression obtained by expressing the membrane potential v^{(l)}ᵢ(t) of the neuron model using the weighting coefficients w^{(l)}ᵢⱼ of the spikes input to the neuron model, and the firing times t^{(l-1)}ⱼ of the neuron models that output the spikes to the neuron model.

Furthermore, when the learning unit 120 calculates the derivative of the loss function C, the sub-expression “Σ_{j∈r(l)i} w^{(l)}ᵢⱼ” in the denominator of the fraction on the right side of expression (13) and the firing time “t^{(l)}ᵢ” of the ith neuron model in the lth layer are treated as constants. This corresponds to fixing the integration time interval [t∧^{(l)}ᵢ, t^{(l)}ᵢ].

In this case, the differentiation performed by the learning unit 120 corresponds to an example of performing differentiation of the evaluation function by treating the firing time of the neuron model whose probability of firing is subjected to evaluation, which is included in the expression representing the evaluation function, and the total value of the weightings of the spikes input to the neuron model whose probability of firing is subjected to evaluation, which is included in the denominator of the fraction included in the expression representing the evaluation function, as constants. Here, the loss function C corresponds to an example of an evaluation function. The firing time “t^{(l)}ᵢ” of the ith neuron model in the lth layer corresponds to an example of a firing time of the neuron model whose probability of firing is subjected to evaluation. The value of the sub-expression “Σ_{j∈r(l)} w^{(l)}ᵢⱼ” corresponds to an example of the total value of the weightings of the spikes input to the neuron model whose probability of firing is subjected to evaluation, which is included in the denominator of the fraction included in the expression representing the evaluation function.

(When τᵥ=∞ and τₗ=τ)

When τᵥ=∞ and τₗ=τ, the membrane potential v^{(l)}ᵢ of the ith neuron model in the ith layer is expressed as in expression (14).

$${ν}_{i}^{( l )} ( t ) = τ {\sum }_{j = 1}^{{N}^{( l - 1 )}} {w}_{ij}^{( l )} θ ( t - {t}_{j}^{( l - 1 )} ) [ 1 - exp ( - \frac{t - {t}_{j}^{( l - 1 )}}{τ} ) ] \qquad ( 14 )$$

The firing time t^{(l)}ᵢ is expressed as in expression (15).

$${t}_{i}^{( l )} = τ ln [ \frac{{\sum }_{j ∈ {Γ}_{i}^{( l )}} {w}_{ij}^{( l )} exp ( \frac{{t}_{j}^{( l - 1 )}}{τ} )}{{\sum }_{j ∈ {Γ}_{i}^{( l )}} {w}_{i j}^{( l )} - {V}_{th} {τ}^{- 1}} ] \qquad ( 15 )$$

The time t∧^{(l)}ᵢ at which the membrane potential v^{(l)}ᵢ reaches the constant v∧ is expressed as in expression (16).

$${\hat{t}}_{i}^{( l )} = τ ln [ \frac{{\sum }_{j ∈ {Γ}_{i}^{( l )}} {w}_{ij}^{( l )} exp ( \frac{{t}_{j}^{( l - 1 )}}{τ} )}{{\sum }_{j ∈ {Γ}_{i}^{( l )}} {w}_{i j}^{( l )} - \hat{v} {τ}^{- 1}} ] \qquad ( 16 )$$

From expressions (15) and (16), t^{(l)}ᵢ-t∧^{(l)}ᵢ is expressed as in expression (17).

$${t}_{i}^{( l )} - {\hat{t}}_{i}^{( l )} = τ ln \frac{{\sum }_{j ∈ {Γ}_{i}^{( l )}} {w}_{ij}^{( l )} exp ( \frac{{t}_{j}^{( l - 1 )}}{τ} )}{{\sum }_{j ∈ {Γ}_{i}^{( l )}} {w}_{i j}^{( l )} - {V}_{th} {τ}^{- 1}} - τ ln \frac{{\sum }_{j ∈ {Γ}_{i}^{( l )}} {w}_{ij}^{( l )} exp ( \frac{{t}_{j}^{( l - 1 )}}{τ} )}{{\sum }_{j ∈ {Γ}_{i}^{( l )}} {w}_{i j}^{( l )} - \hat{v} {τ}^{- 1}} = τ ln \frac{{\sum }_{j ∈ {Γ}_{i}^{( l )}} {w}_{ij}^{( l )} - \hat{v} {τ}^{- 1}}{{\sum }_{j ∈ {Γ}_{i}^{( l )}} {w}_{i j}^{( l )} - {V}_{th} {τ}^{- 1}} = τ ln ( 1 + \frac{( {V}_{t h} - \hat{v} ) {τ}^{- 1}}{{\sum }_{j ∈ {Γ}_{i}^{( l )}} {w}_{i j}^{( l )} - {V}_{th} {τ}^{- 1}} ) \qquad ( 17 )$$

When the value of the constant v∧ is sufficiently close to the value of the threshold membrane potential Vₜₕ, it is possible to transform expression (17) as in expression (18) by using an approximation by a Taylor expansion of an exponential function.

$${t}_{i}^{( l )} - {\hat{t}}_{i}^{( l )} = \frac{{V}_{t ℏ} - \hat{v}}{{\sum }_{j ∈ {Γ}_{i}^{( l )}} {w}_{i j}^{( l )} - {V}_{th} {τ}^{- 1}} \qquad ( 18 )$$

Expression (6) can be transformed as in expression (19).

$${V}_{i}^{( l )} = \frac{1}{{V}_{t h} - \hat{ν}} {\int }_{{\hat{t}}_{i}^{( l )}}^{{t}_{i}^{( l )}} {ν}_{i}^{( l )} ( t ) dt = \frac{τ}{{V}_{t h} - \hat{ν}} {\int }_{{\hat{t}}_{i}^{( l )}}^{{t}_{i}^{( l )}} {\sum }_{j = 1}^{{N}^{( l - 1 )}} {w}_{ij}^{( l )} θ ( t - {t}_{j}^{( l - 1 )} ) [ 1 - exp ( - \frac{t - {t}_{j}^{( l - 1 )}}{τ} ) ] dt = {\frac{τ}{{V}_{t h} - \hat{ν}} [ {\sum }_{j ∈ {Γ}_{i}^{( l )}} {w}_{i j}^{( l )} \{ t + τ exp ( \frac{{t}_{j}^{( l - 1 )}}{τ} ) exp ( - \frac{t}{τ} ) \} ]}_{{\hat{t}}_{i}^{( l )}}^{{t}_{𝔦}^{( l )}} = \frac{τ}{{V}_{t h} - \hat{ν}} {\sum }_{j ∈ {Γ}_{i}^{( l )}} {w}_{i j}^{( l )} [ \text{} ( {t}_{i}^{( l )} - {\hat{t}}_{i}^{( l )} ) + τ exp ( \frac{{t}_{j}^{( l - 1 )}}{τ} ) \{ exp ( - \frac{{t}_{i}^{( l )}}{τ} ) - exp ( - \frac{{\hat{t}}_{i}^{( l )}}{τ} ) \} ] = \frac{τ}{{V}_{t h} - \hat{ν}} \text{} {\sum }_{j ∈ {Γ}_{i}^{( l )}} {w}_{i j}^{( l )} [ \text{} ( {t}_{i}^{( l )} - {\hat{t}}_{i}^{( l )} ) + τ exp ( \frac{{t}_{j}^{( l - 1 )}}{τ} ) exp ( - \frac{{t}_{i}^{( l )}}{τ} ) \{ 1 - exp ( \frac{{t}_{i}^{( t )} - {\hat{t}}_{i}^{( l )}}{τ} ) \} ] \qquad ( 19 )$$

When the value of the constant v∧ is sufficiently close to the value of the threshold membrane potential Vₜₕ, and the value of t⁽¹⁾ᵢ−t∧^{(l)}ᵢ is sufficiently small compared to the value oft, expression (19) can be transformed as in expression (20).

$${V}_{i}^{( l )} = \frac{τ}{{V}_{t h} - \hat{ν}} {\sum }_{j ∈ {Γ}_{i}^{( l )}} {w}_{i j}^{( l )} [ ( {t}_{i}^{( l )} - {\hat{t}}_{i}^{( l )} ) - exp ( \frac{{t}_{j}^{( l - 1 )}}{τ} ) exp ( - \frac{{t}_{i}^{( l )}}{τ} ) ( {t}_{i}^{( t )} - {\hat{t}}_{i}^{( l )} ) ] = \frac{τ ( {t}_{i}^{( l )} - {\hat{t}}_{i}^{( l )}}{{V}_{t h} - \hat{ν}} {\sum }_{j ∈ {Γ}_{i}^{( l )}} {w}_{i j}^{( l )} [ 1 - exp ( \frac{{t}_{j}^{( l - 1 )}}{τ} ) exp ( - \frac{{t}_{i}^{( l )}}{τ} ) ] \qquad ( 20 )$$

Expression (20) can be transformed as in expression (21) using expression (18).

$${V}_{i}^{( l )} = τ \frac{1}{{\sum }_{j ∈ {Γ}_{i}^{( l )}} {w}_{i j}^{( l )} - {V}_{t h} {τ}^{- 1}} {\sum }_{j ∈ {Γ}_{i}^{( l )}} {w}_{i j}^{( l )} [ 1 - exp ( \frac{{t}_{j}^{( l - 1 )}}{τ} ) exp ( - \frac{{t}_{i}^{( l )}}{τ} ) ] \qquad ( 21 )$$

Expression (21) can be transformed as in expression (22)

$${V}_{i}^{( 1 \}} = τ \frac{1}{{\sum }_{j ∈ {Γ}_{i}^{( l )}} {w}_{i j}^{( l )} - {V}_{t h} {τ}^{- 1}} [ ( {\sum }_{j ∈ {Γ}_{i}^{( l )}} {w}_{i j}^{( l )} ) - exp ( - \frac{{t}_{i}^{( l )}}{τ} ) {\sum }_{j ∈ {Γ}_{i}^{( l )}} {w}_{i j}^{( l )} exp ( \frac{{t}_{j}^{( l - 1 )}}{τ} ) ] \qquad ( 22 )$$

In expression (22), the sub-expression V^{(l)}ᵢ is an expression in which the membrane potential v^{(l)}ᵢ(t) does not explicitly appear. Therefore, according to expression (22), the learning unit 120 can calculate the time-integrated loss of the membrane potential without the need to acquire the value of the membrane potential v^{(l)}ᵢ(t). This eliminates the need to provide a mechanism that measures the value of the membrane potential for each neuron model, even when the value of the membrane potential is represented by an analog value such as a current value or a voltage value. According to the neural network system 100, in this respect, the burden on the hardware configuration can be relatively reduced.

Here, in expression (14), the membrane potential v^{(l)}ᵢ(t) is expressed using the weighting coefficients w^{(l)}ᵢⱼ of the spikes input to the ith neuron model in the lth layer, and the firing times t^{(l-1)}ⱼ of the neuron models that output the spikes to the neuron model. The sub-expression V^{(l)}ᵢ in expression (22) corresponds to an example of a sub-expression obtained by expressing the membrane potential v^{(l)}ᵢ(t) of the neuron model using the weighting coefficients wᵢⱼ of the spikes input to the neuron model, and the firing times t^{(l-1)}ⱼ of the neuron models that output the spikes to the neuron model.

Furthermore, when the learning unit 120 calculates the derivative of the loss function C, the sub-expression “Σ_{j∈r(l)} W^{(l)}ᵢⱼ” included in the denominator of the fraction on the right side of expression (22) and the firing time “t^{(l)}ᵢ” of the ith neuron model in the lth layer are treated as constants. This corresponds to fixing the integration time interval [t∧^{(l)}ᵢ, t^{(l)}ᵢ] In this case, the differentiation performed by the learning unit 120 corresponds to an example of performing differentiation of the evaluation function by treating the firing time of the neuron model whose probability of firing is subjected to evaluation, which is included in the expression representing the evaluation function, and the total value of the weightings of the spikes input to the neuron model whose probability of firing is subjected to evaluation, which is included in the denominator of the fraction included in the expression representing the evaluation function, as constants. Here, the loss function C corresponds to an example of an evaluation function. The firing time “t^{(l)}ᵢ” of the ith neuron model in the lth layer corresponds to an example of a firing time of the neuron model whose probability of firing is subjected to evaluation. The value of the sub-expression “Σ_{j∈r(l)i} w^{(l)}ᵢⱼ” corresponds to an example of the total value of the weightings of the spikes input to the neuron model whose probability of firing is subjected to evaluation, which is included in the denominator of the fraction included in the expression representing the evaluation function.

(When, τᵥ=2τₗ=2τ)

When τᵥ=2τₗ=2τ, the membrane potential v^{(l)}ᵢ of the ith neuron model in the ith layer is expressed as in expression (23).

$${ν}_{i}^{( l )} ( t ) = 2 τ {\sum }_{j = 1}^{{N}^{( l - 1 )}} {w}_{ij}^{( l )} θ ( t - {t}_{j}^{( l - 1 )} ) [ exp ( - \frac{t - {t}_{j}^{( l - 1 )}}{2 τ} ) - exp ( - \frac{t - {t}_{j}^{( l - 1 )}}{τ} ) ] \qquad ( 23 )$$

As a result of the firing condition Vₜₕ=v^{(l)}ᵢ(t^{(l)}ᵢ), the firing time t^{(l)}ᵢ satisfies the condition shown in expression (24).

$$exp ( - \frac{{t}_{i}^{( l )}}{2 τ} ) {\sum }_{j ∈ {Γ}_{i}^{( l )}} {w}_{i j}^{( l )} exp ( \frac{{t}_{j}^{( l - 1 )}}{τ} ) - exp ( - \frac{{t}_{i}^{( l )}}{τ} ) {\sum }_{j ∈ {Γ}_{i}^{( l )}} {w}_{i j}^{( l )} exp ( \frac{{t}_{j}^{( l - 1 )}}{τ} ) = \frac{{V}_{t h}}{2 τ} \qquad ( 24 )$$

Expression (24) can be transformed as in expression (25).

$${[ exp ( - \frac{{t}_{i}^{( l )}}{2 τ} ) ]}^{2} {\sum }_{j ∈ {Γ}_{i}^{( l )}} {w}_{i j}^{( l )} exp ( \frac{{t}_{j}^{( l - 1 )}}{τ} ) - exp ( - \frac{{t}_{i}^{( l )}}{2 τ} ) {\sum }_{j ∈ {Γ}_{i}^{( l )}} {w}_{i j}^{( l )} exp ( \frac{{t}_{j}^{( l - 1 )}}{2 τ} ) + \frac{{V}_{t h}}{2 τ} = 0 \qquad ( 25 )$$

Expression (25) is expressed as in expression (26).

$${{a}_{i}^{( l )} [ exp ( - \frac{{t}_{i}^{( l )}}{2 τ} ) ]}^{2} - {b}_{i}^{( l )} exp ( - \frac{{t}_{i}^{( l )}}{2 τ} ) + \frac{{V}_{th}}{2 τ} = 0 \qquad ( 26 )$$

a^{(l)}ᵢ is expressed as in expression (27).

$${a}_{i}^{( l )} = {\sum }_{j ∈ {Γ}_{i}^{( l )}} {w}_{i j}^{( l )} exp ( \frac{{t}_{j}^{( l - 1 )}}{τ} ) \qquad ( 27 )$$

b^{(l)}ᵢ is expressed as in expression (28).

$${b}_{i}^{( l )} = {\sum }_{j ∈ {Γ}_{i}^{( l )}} {w}_{i j}^{( l )} exp ( \frac{{t}_{j}^{( l - 1 )}}{2 τ} ) \qquad ( 28 )$$

With respect to the firing time t^{(l)}ᵢ, expression (29) can be obtained from expression (25) using the solution formula for quadratic expressions.

$$exp ( - \frac{{t}_{i}^{( l )}}{2 τ} ) = \frac{{b}_{i}^{( l )} + \sqrt{{( {b}_{i}^{( l )} )}^{2} - 2 {a}_{i}^{( l )} {τ}^{- 1} {V}_{th}}}{2 {a}_{i}^{( l )}} \qquad ( 29 )$$

Here, the other solution of the quadratic expression is ignored because it is a solution where the membrane potential v(I); decreases from a value larger than the threshold Vₜₕ to a value smaller than the threshold Vₜₕ.

Expression (30) is obtained from expression (29).

$$\begin{matrix}{t}_{i}^{( l )} = - 2 τ ln [ \frac{{b}_{i}^{( l )} + \sqrt{{( {b}_{i}^{( l )} )}^{2} - 2 {a}_{i}^{( l )} {τ}^{- 1} {V}_{th}}}{2 {a}_{i}^{( l )}} ] \\ = 2 τ ln [ \frac{2 {a}_{i}^{( l )}}{{b}_{i}^{( l )} + \sqrt{{( {b}_{i}^{( l )} )}^{2} - 2 {a}_{i}^{( l )} {τ}^{- 1} {V}_{th}}} ]\end{matrix} \qquad ( 30 )$$

Expression (30) can be transformed as in expression (31).

$${t}_{i}^{( l )} = 2 τ ln [ τ \frac{{b}_{i}^{( l )} - \sqrt{{( {b}_{i}^{( l )} )}^{2} - 2 {a}_{i}^{( l )} {τ}^{- 1} {V}_{th}}}{{V}_{t h}} ] \qquad ( 31 )$$

In order to prevent deterioration of calculation accuracy due to loss of digits, the use of expression (30) instead of expression (31) can be considered when implementing the neuron model.

The time t∧^{(l)}ᵢ at which the membrane potential v^{(l)}ᵢ reaches the constant v∧ is expressed as in expression (32).

$${\hat{t}}_{i}^{( l )} = 2 τ ln [ \frac{2 {a}_{i}^{( l )}}{{b}_{i}^{( l )} + \sqrt{{( {b}_{i}^{( l )} )}^{2} - 2 {a}_{i}^{( l )} {τ}^{- 1} \hat{v}}} ] \qquad ( 32 )$$

From expressions (30) and (32), t^{(l)}ᵢ−t∧^{(l)}ᵢ is expressed as in expression (33).

$${t}_{i}^{( l )} - {\hat{t}}_{i}^{( l )} = 2 τ ln \frac{{b}_{i}^{( l )} + \sqrt{{( {b}_{i}^{( l )} )}^{2} - 2 {a}_{i}^{( l )} {τ}^{- 1} \hat{v}}}{{b}_{i}^{( l )} + \sqrt{{( {b}_{i}^{( l )} )}^{2} - 2 {a}_{i}^{( l )} {τ}^{- 1} {V}_{th}}} \qquad ( 33 )$$

When v∧ is treated as a variable representing the membrane potential and brought sufficiently close to the threshold Vₜₕ, and a first-order Taylor expansion is performed with respect to v∧ around the threshold Vₜₕ, expression (33) is transformed as in expression (34).

$${t}_{i}^{( l )} - {\hat{t}}_{i}^{( l )} = 2 τ ln \frac{{b}_{i}^{( l )} + \sqrt{{( {b}_{i}^{( l )} )}^{2} - 2 {a}_{i}^{( l )} {τ}^{- 1} {V}_{th}} + \frac{{a}_{i}^{( l )}}{\sqrt{{( {b}_{i}^{( l )} )}^{2} - 2 {a}_{i}^{( l )} {τ}^{- 1}}} ( {V}_{th} - \hat{v} )}{{b}_{i}^{( l )} + \sqrt{{( {b}_{i}^{( l )} )}^{2} - 2 {a}_{i}^{( l )} {τ}^{- 1} {V}_{th}}} \qquad ( 34 )$$

Expression (34) can be transformed as in expression (35).

$${t}_{i}^{( l )} - {\hat{t}}_{i}^{( l )} = 2 τ ln ( 1 + \frac{{a}_{i}^{( l )} {τ}^{- 1}}{( {b}_{i}^{( l )} + \sqrt{{( {b}_{i}^{( l )} )}^{2} - 2 {a}_{i}^{( l )} {τ}^{- 1} {V}_{th}} ) ( \sqrt{{( {b}_{i}^{( l )} )}^{2} - 2 {a}_{i}^{( l )} {τ}^{- 1} {V}_{th}} )} ( {V}_{th} - \hat{v} ) ) \qquad ( 35 )$$

When the value of v∧ is sufficiently close to the threshold Vₜₕ, it is possible to transform expression (35) as in expression (36) by using an approximation by a Taylor expansion of an exponential function.

$$\begin{matrix}{t}_{i}^{( l )} - {\hat{t}}_{i}^{( l )} = \frac{2 {a}_{i}^{( l )}}{( {b}_{i}^{( l )} + \sqrt{{( {b}_{i}^{( l )} )}^{2} - 2 {a}_{i}^{( l )} {τ}^{- 1} {V}_{th}} ) ( \sqrt{{( {b}_{i}^{( l )} )}^{2} - 2 {a}_{i}^{( l )} {τ}^{- 1} {V}_{th}} )} ( {V}_{th} - \hat{v} ) \\ = {α}_{i}^{( l )} ( {V}_{th} - \hat{v} )\end{matrix} \qquad ( 36 )$$

a^{(l)}ᵢ is expressed as in expression (37).

$${α}_{i}^{( l )} = \frac{2 {a}_{i}^{( l )}}{( {b}_{i}^{( l )} + \sqrt{{( {b}_{i}^{( l )} )}^{2} - 2 {a}_{i}^{( l )} {τ}^{- 1} {V}_{th}} ) ( \sqrt{{( {b}_{i}^{( l )} )}^{2} - 2 {a}_{i}^{( l )} {τ}^{- 1} {V}_{th}} )} \qquad ( 37 )$$

Expression (6) can be transformed as in expression (38).

$$\begin{matrix}{V}_{i}^{( l )} = \frac{1}{{V}_{th} - \hat{v}} {\int }_{{\hat{t}}_{i}^{( l )}}^{{t}_{i}^{( l )}} {v}_{i}^{( l )} ( t ) dt \\ = \frac{2 τ}{{V}_{th} - \hat{v}} {\int }_{{\hat{t}}_{i}^{( l )}}^{{t}_{i}^{( l )}} {\sum }_{j = 1}^{{N}^{( l - 1 )}} {w}_{ij}^{( l )} θ ( t - {t}_{j}^{( l - 1 )} ) [ exp ( - \frac{t - {t}_{j}^{( l - 1 )}}{2 τ} ) - exp ( - \frac{t - {t}_{j}^{( l - 1 )}}{τ} ) ] dt \\ = \frac{2 τ}{{V}_{th} - \hat{v}} {\sum }_{j ∈ {Γ}_{i}^{( l )}} {[ {w}_{ij}^{( l )} \{ - 2 τ exp ( - \frac{t - {t}_{j}^{( l - 1 )}}{2 τ} ) + τ exp ( - \frac{t - {t}_{j}^{( l - 1 )}}{τ} ) \} ]}_{{\hat{t}}_{i}^{( l )}}^{{t}_{i}^{( l )}} \\ = \frac{2 {τ}^{2}}{{V}_{th} - \hat{v}} {\sum }_{j ∈ {Γ}_{i}^{( l )}} {{w}_{ij}^{( l )} [ - 2 exp ( \frac{{t}_{j}^{( l - 1 )}}{2 τ} ) exp ( - \frac{t}{2 τ} ) + exp ( \frac{{t}_{j}^{( l - 1 )}}{τ} ) exp ( - \frac{t}{τ} ) ]}_{{\hat{t}}_{i}^{( l )}}^{{t}_{i}^{( l )}} \\ = \frac{2 {τ}^{2}}{{V}_{th} - \hat{v}} {\sum }_{j ∈ {Γ}_{i}^{( l )}} {w}_{ij}^{( l )} [ - 2 exp ( \frac{{t}_{j}^{( l - 1 )}}{2 τ} ) \{ exp ( - \frac{{t}_{i}^{( l )}}{2 τ} ) - exp ( - \frac{{\hat{t}}_{i}^{( l )}}{2 τ} ) \} + exp ( \frac{{t}_{j}^{( l - 1 )}}{τ} ) \{ exp ( - \frac{{t}_{i}^{( l )}}{τ} ) - exp ( - \frac{{\hat{t}}_{i}^{( l )}}{τ} ) \} ] \\ = \frac{2 {τ}^{2}}{{V}_{th} - \hat{v}} {\sum }_{j ∈ {Γ}_{i}^{( l )}} {w}_{ij}^{( l )} [ - 2 exp ( \frac{{t}_{j}^{( l - 1 )}}{2 τ} ) exp ( - \frac{{t}_{i}^{( l )}}{2 τ} ) \{ 1 - exp ( \frac{{t}_{i}^{( l )} - {\hat{t}}_{i}^{( l )}}{2 τ} ) \} + exp ( \frac{{t}_{j}^{( l - 1 )}}{τ} ) exp ( - \frac{{t}_{i}^{( l )}}{τ} ) \{ 1 - exp ( \frac{{t}_{i}^{( l )} - {\hat{t}}_{i}^{( l )}}{τ} ) \} ]\end{matrix} \qquad ( 38 )$$

When an approximation by a Taylor expansion of an exponential function is used, expression (38) can be transformed as in expression (39).

$$\begin{matrix}{V}_{i}^{( l )} = \frac{2 {τ}^{2}}{{V}_{th} - \hat{v}} {\sum }_{j ∈ {Γ}_{i}^{( l )}} {w}_{ij}^{( l )} [ exp ( \frac{{t}_{j}^{( l - 1 )}}{2 τ} ) exp ( - \frac{{t}_{i}^{( l )}}{2 τ} ) ( \frac{{t}_{i}^{( l )} - {\hat{t}}_{i}^{( l )}}{τ} ) - exp ( \frac{{t}_{j}^{( l - 1 )}}{τ} ) exp ( - \frac{{t}_{i}^{( l )}}{τ} ) ( \frac{{t}_{i}^{( l )} - {\hat{t}}_{i}^{( l )}}{τ} ) ] \\ = \frac{2 τ ( {t}_{i}^{( l )} - {\hat{t}}_{i}^{( l )} )}{{V}_{th} - \hat{v}} [ exp ( - \frac{{t}_{i}^{( l )}}{2 τ} ) {\sum }_{j ∈ {Γ}_{i}^{( l )}} {w}_{ij}^{( l )} exp ( \frac{{t}_{j}^{( l - 1 )}}{2 τ} ) - exp ( - \frac{{t}_{i}^{( l )}}{τ} ) {\sum }_{j ∈ {Γ}_{i}^{( l )}} {w}_{ij}^{( l )} exp ( \frac{{t}_{j}^{( l - 1 )}}{τ} ) ]\end{matrix} \qquad ( 39 )$$

Expression (39) can be expressed as in expression (40).

$${V}_{i}^{( l )} = 2 {τα}_{i}^{( l )} [ exp ( - \frac{{t}_{i}^{( l )}}{2 τ} ) {a}_{i}^{( l )} - exp ( - \frac{{t}_{i}^{( l )}}{τ} ) {b}_{i}^{( l )} ] \qquad ( 40 )$$

In expression (40), the sub-expression V^{(l)}ᵢ is an expression in which the membrane potential v^{(l)}ᵢ(t) does not explicitly appear. Therefore, according to expression (40), the learning unit 120 can calculate the time-integrated loss of the membrane potential without the need to acquire the value of the membrane potential v^{(l)}ᵢ(t). This eliminates the need to provide a mechanism that measures the value of the membrane potential for each neuron model, even when the value of the membrane potential is represented by an analog value such as a current value or a voltage value. According to the neural network system 100, in this respect, the burden on the hardware configuration can be relatively reduced.

Here, in expression (23), the membrane potential v^{(l)}ᵢ(t) is expressed using the weighting coefficients w(% of the spikes input to the ith neuron model in the lth layer, and the firing times t^{(l-1)}ⱼ of the neuron models that output the spikes to the neuron model. The sub-expression V^{(l)}ᵢ in expression (40) corresponds to an example of a sub-expression obtained by expressing the membrane potential v^{(l)}ᵢ(t) of the neuron model using the weighting coefficients w(l) of the spikes input to the neuron model, and the firing times t^{(l-1)}ⱼ of the neuron models that output the spikes to the neuron model.

Furthermore, when the learning unit 120 calculates the derivative of the loss function C, the firing time “ti” of the ith neuron model in the ith layer and a^{(l)}ᵢ included in expression (40) are treated as constants. This corresponds to fixing the integration time interval [t∧^{(l)}ᵢ, t^{(l)}ᵢ].

In this case, the differentiation performed by the learning unit 120 corresponds to an example of performing differentiation of the evaluation function by treating the firing time a^{(l)}ᵢ of the neuron model whose probability of firing is subjected to evaluation, which is included in the expression representing the evaluation function, as a constant. Here, the loss function C corresponds to an example of an evaluation function. The firing time “t^{(l)}ᵢ” of the ith neuron model in the lth layer corresponds to an example of a firing time of the neuron model whose probability of firing is subjected to evaluation.

### (Loss Relating to Firing Condition)

The sub-expression Q in expression (1) is expressed as in expression (41).

$$Q = {\sum }_{l} {player}^{( l )} {\sum }_{i} {Q}_{i}^{( l )} \qquad ( 41 )$$

When the loss function includes both the sub-expression V and the sub-expression Q, the value of player^{(l)} in the sub-expression V and the value of player^{(l)} in the sub-expression Q may be set to the same value, or may be set to different values.

Q^{(l)}ᵢ is expressed as in expression (42).

$${Q}_{i}^{( l )} = \{ \begin{matrix}{\sum }_{j ∈ {Γ}_{i}^{( l )}} {w}_{i j}^{( l )} , & if {t}_{i}^{( l )} < {t}^{r e f} \\ 0 , & otherwise\end{matrix} \qquad ( 42 )$$

Here, t^{ref} represents a reference time of the firing time of the final layer (output layer). That is to say, firings after the time t^{ref} are ignored in the processing performed by the spiking neural network 110.

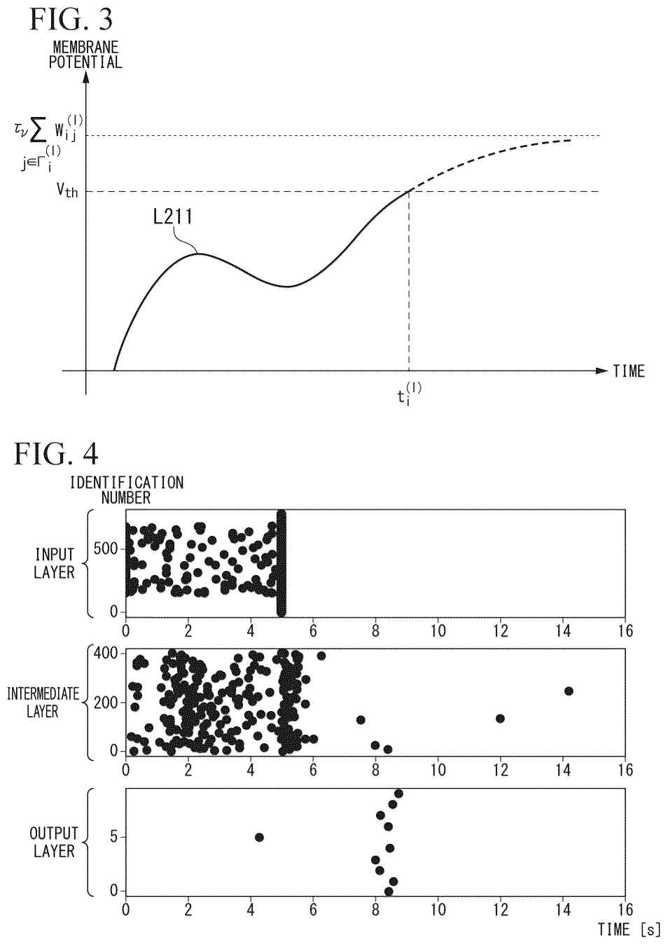

FIG. 3 is a diagram showing an example of a firing condition of a neuron model. The horizontal axis of the graph in FIG. 3 represents time, and the vertical axis represents the membrane potential.

The line L211 represents the membrane potential v^{(l)}ᵢ(t) of the ith neuron model in the lth layer.

In the example of FIG. 3, the membrane potential represented by the line L211 has reached the threshold membrane potential Vₜₕ at the time t^{(l)}ᵢ, which is the firing time, and the neuron model has fired.

When it is assumed that the neuron model does not accept input spikes after the firing time t^{(l)}ᵢ, and the membrane potential v^{(l)}ᵢ(t) changes after the firing time t^{(l)}ᵢ under the same conditions as before the firing, at infinite time, that is to say, at t→∞, the membrane potential converges to τvΣ_{j∈r(l)i} w^{(l)}ᵢⱼ. From this, expression (43) can be regarded as a firing condition.

$${\sum }_{j ∈ {Γ}_{i}^{( l )}} {w}_{i j}^{( l )} \geq {V}_{th} {τ}_{v}^{- 1} \qquad ( 43 )$$

As the value of Σ_{j∈r(i)i} w^{(l)}ᵢⱼ becomes smaller, the firing condition represented by expression (43) becomes more difficult to hold, which is considered to suppress firing. Therefore, it is possible to use Σ_{j∈r(l)i} w^{(l)}ᵢⱼ as an index of the probability of the neuron model firing. Using the index, the loss relating to the firing condition (sub-expression Q), in which a lower probability of the neuron model firing indicates a better evaluation, can be defined as in expressions (41) and (42) above.

The sub-expression Q shown in expressions (41) and (42) represents an example of a sub-expression that, for a neuron model that has fired, indicates a better evaluation as a total value of the weighting coefficients of the spikes that have been input to the neuron model decreases.

Because the timings at which the firing of the neuron models is valid is limited to a finite time interval of [0, t^{ref}], the condition t^{(l)}ᵢ<t^{ref} is set.

### (Experimental Results)

Experiments were conducted to confirm the operation of the neural network system 100. First, a spiking neural network was trained using a loss function provided with the time-integrated loss term γ₂V of the membrane potential, and the firing state of the neuron models was observed. Here, a three-layer spiking neural network was used in which the input layer included 784 neuron models, the intermediate layer included 400 neuron models, and the output layer included 10 neuron models. In terms of the hyperparameters, τᵥ=τₗ=∞, t^{ref}=8 (seconds), and the coefficient γ of the temporal penalty term was γ=10⁻⁴. The learning rate it was set to η=10⁻⁴. Character recognition learning was performed using MNIST as training data for values of the coefficient γ₂ of 0, 2.3×10⁻⁷, and 4.8×10⁻⁶.

FIG. 4 is a diagram showing a neuron model firing state observed when γ₂=0. Therefore, FIG. 4 shows the firing state of the neuron models when the degree of influence of the time-integrated loss term γ₂V of membrane potential is set to 0.

The horizontal axis of the graph in FIG. 4 represents time. The vertical axis represents the identification number of the neuron model, and the identification number of each neuron is assigned on the horizontal axis for each of the input layer, the intermediate layer, and the output layer.

The firing times of the neuron models that fired are represented by dots (black circles).

Furthermore, in the example of FIG. 4, the recognition rate of the spiking neural network was 98.05%.

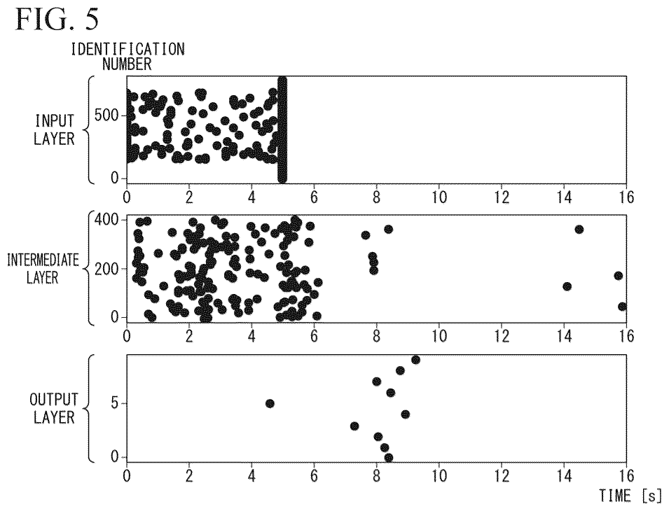

FIG. 5 is a diagram showing neuron model firing states observed when γ₂=2.3×10⁻⁷.

The horizontal axis of the graph in FIG. 5 represents time. The vertical axis represents the identification number of the neuron model, and the identification number of each neuron is assigned on the horizontal axis for each of the input layer, the intermediate layer, and the output layer.

The firing times of the neuron models that fired are represented by dots (black circles).

Furthermore, in the example of FIG. 5, the recognition rate of the spiking neural network was 97.84%.

In the example of FIG. 5, the number of firings of the neuron models in the intermediate layer is smaller than in the example of FIG. 4. Furthermore, in terms of the recognition rate, a recognition rate is obtained in the example of FIG. 5 that is comparable to that of FIG. 4.

In this way, in the example of FIG. 5, the power consumption can be reduced compared to the example of FIG. 4, and a recognition rate that is comparable to that of the example of FIG. 4 can be obtained.

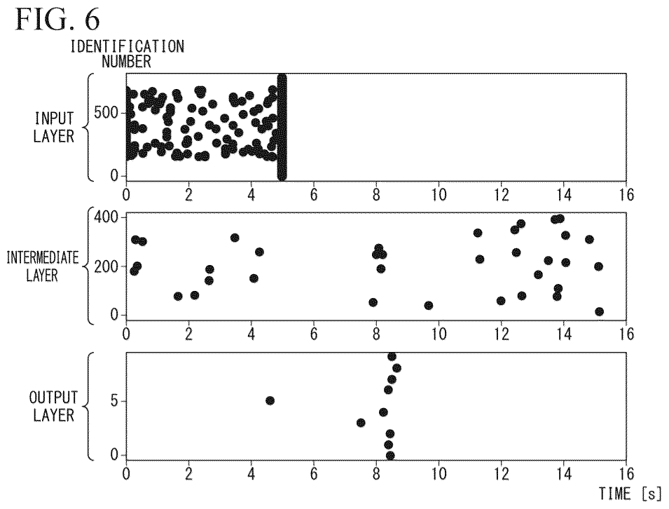

FIG. 6 is a diagram showing neuron model firing states observed when γ₂=4.8×10⁻⁶. Therefore, FIG. 6 shows the firing states of the neuron models when the degree of influence of the time-integrated loss term γ₂V of membrane potential has been further strengthened (increased) from that in FIG. 5.

The horizontal axis of the graph in FIG. 6 represents time. The vertical axis represents the identification number of the neuron model, and the identification number of each neuron is assigned on the horizontal axis for each of the input layer, the intermediate layer, and the output layer.

The firing times of the neuron models that fired are represented by dots (black circles).

Furthermore, in the example of FIG. 6, the recognition rate of the spiking neural network was 97.6%.

In the example of FIG. 6, the number of firings of the neuron models in the intermediate layer is even smaller than in the example of FIG. 5. Furthermore, in terms of the recognition rate, a recognition rate is obtained in the example of FIG. 6 that is comparable to that of FIG. 4 and FIG. 5.

In this way, in the example of FIG. 6, the power consumption can be further reduced compared to the example of FIG. 5, and a recognition rate that is comparable to that of the example of FIG. 5 can be obtained.

In this way, it was confirmed that the number of firings of the neuron models could be reduced by providing the time-integrated loss term γ₂V of the membrane potential. As a result of reducing the number of firings of the neuron models, it is expected that the power consumption of the spiking neural network can be reduced. Furthermore, in terms of the recognition rate of the spiking neural network, even when the number of firings of the neuron models was reduced, the recognition rate was comparable to that of the case where the number of firings of the neuron models was not reduced.

In addition, for each case where the time-integrated loss term γ₂V of the membrane potential was used, and the loss term γ₃Q relating to the firing condition was used, the spiking neural network was trained by setting a variety of values of the coefficients γ₂ and γ₃, and the relationship between the recognition rate of the neural network and the firing proportion of the neuron models in the intermediate layer was observed. Here, the recognition rate is calculated by dividing the number of data that have been correctly recognized by the total number of data.

Here, a three-layer spiking neural network and a five-layer spiking neural network were respectively used. The hyperparameter values were the same as in the experiments described with reference to FIG. 4 to FIG. 6.

For the three-layer spiking neural network, a spiking neural network was used in which the input layer included 784 spiking neuron models, the intermediate layer included 400 neuron models, and the output layer included 10 neuron models.

For the five-layer spiking neural network, a spiking neural network was used in which the input layer included 784 neuron models, three intermediate layers, namely a first intermediate layer, a second intermediate layer, and a third intermediate layer, each included 400 neuron models, and the output layer included 10 neuron models.

In terms of the training data, character recognition training was performed for each case where MNIST was used, and Fashion-MNIST was used.

As the firing proportion of the neuron models, the firing proportion per neuron model was calculated in repeated experiments. Specifically, the average value of the firing proportion of each neuron model was calculated for all of the neuron models included in the intermediate layer by calculating, for each neuron model, the firing proportion by dividing the number of firings of each neuron model by the number of repeated experiments. In the configuration having three intermediate layers, an average value was calculated for each intermediate layer.

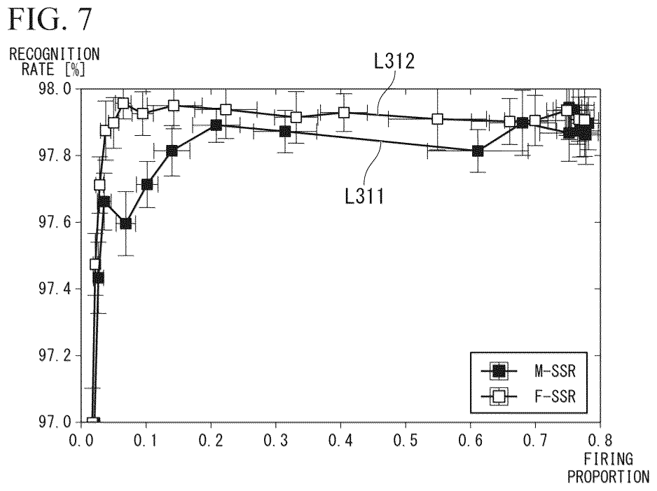

FIG. 7 is a diagram showing a first example of a relationship between the recognition rate of a neural network and the firing proportion of the neuron models in the intermediate layer. FIG. 7 shows an example in which a three-layer spiking neural network is used and MNIST is used as training data.

The horizontal axis of the graph in FIG. 7 represents the firing proportion. The vertical axis represents the recognition rate.

The line L311 represents an example of the relationship between the recognition rate of the neural network and the firing proportion of the neuron models in the intermediate layer when the time-integrated loss term γ₂V of the membrane potential is used. The line L312 represents an example of the relationship between the recognition rate of the neural network and the firing proportion of the neuron models in the intermediate layer when the loss term γ₃Q is used.

In the example of FIG. 7, in each case where the time-integrated loss term γ₂V of the membrane potential was used, and the loss term γ₃Q relating to the firing condition was used, a recognition rate in a range of 97.6% to 98.0% was obtained in a firing proportion range of 0.1 to 0.8. In this way, it was possible to approximately maintain the recognition accuracy of the neural network and reduce the firing proportion.

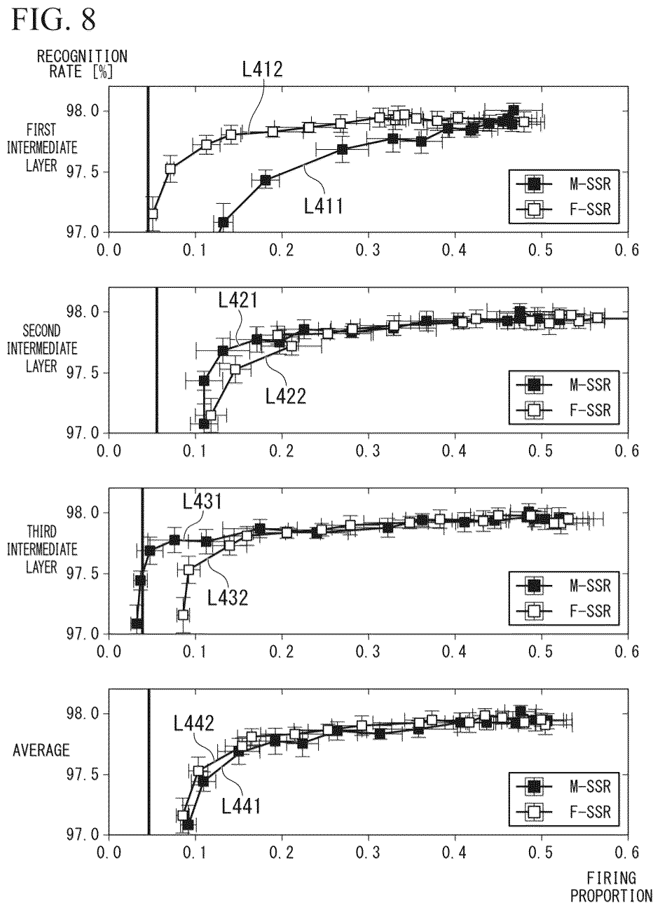

FIG. 8 is a diagram showing a second example of a relationship between the recognition rate of a neural network and the firing proportion of the neuron models in the intermediate layers. FIG. 8 shows an example in which a five-layer spiking neural network is used and MNIST is used as training data.

The horizontal axis of the graph in FIG. 8 represents the firing proportion. The vertical axis represents the recognition rate. FIG. 8 shows the relationship between the firing proportion and the recognition rate for each of the first intermediate layer, the second intermediate layer, and the third intermediate layer, and an average value of the firing proportion of the neuron models in each of the three intermediate layers.

The line L411 represents an example of the relationship between the recognition rate of the neural network and the firing proportion of the neuron models in the first intermediate layer when the time-integrated loss term γ₂V of the membrane potential is used. The line L412 represents an example of the relationship between the recognition rate of the neural network and the firing proportion of the neuron models in the first intermediate layer when the loss term γ₃Q is used.

The line L421 represents an example of the relationship between the recognition rate of the neural network and the firing proportion of the neuron models in the second intermediate layer when the time-integrated loss term γ₂V of the membrane potential is used. The line L422 represents an example of the relationship between the recognition rate of the neural network and the firing proportion of the neuron models in the second intermediate layer when the loss term γ₃Q is used.

The line L431 represents an example of the relationship between the recognition rate of the neural network and the firing proportion of the neuron models in the third intermediate layer when the time-integrated loss term γ₂V of the membrane potential is used. The line L432 represents an example of the relationship between the recognition rate of the neural network and the firing proportion of the neuron models in the third intermediate layer when the loss term γ₃Q is used.

The line L441 represents an example of the relationship between the recognition rate of the neural network and the average value of the firing proportion of the neuron models in the first intermediate layer to the third intermediate layer when the time-integrated loss term γ₂V of the membrane potential is used. The line L442 represents an example of the relationship between the recognition rate of the neural network and the average value of the firing proportion of the neuron models in the first intermediate layer to the third intermediate layer when the loss term γ₃Q is used.

In the example of FIG. 8, in each case where the time-integrated loss term γ₂V of the membrane potential was used, and the loss term γ₃Q relating to the firing condition was used, and for each of the first intermediate layer, the second intermediate layer, and the third intermediate layer, a recognition rate in a range of about 97.5% to 98.0% was obtained when the firing proportion was 0.2 or more. In this way, it was possible to approximately maintain the recognition accuracy of the neural network and reduce the firing proportion.

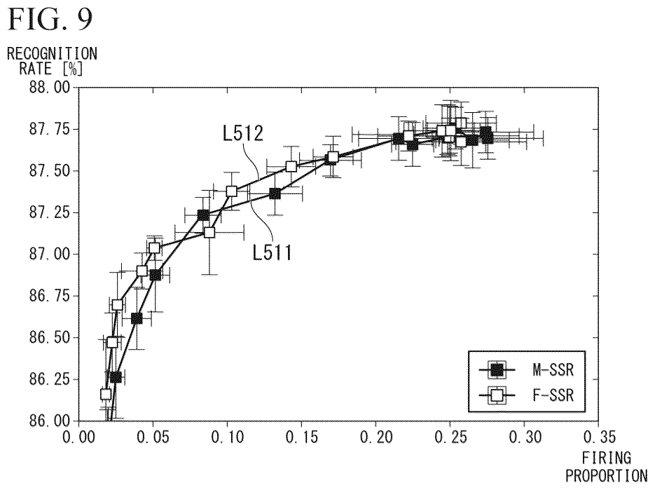

FIG. 9 is a diagram showing a third example of a relationship between the recognition rate of a neural network and the firing proportion of the neuron model in the intermediate layer. FIG. 9 shows an example in which a three-layer spiking neural network is used and Fashion-MNIST is used as training data.

The horizontal axis of the graph in FIG. 9 represents the firing proportion. The vertical axis represents the recognition rate.

The line L511 represents an example of the relationship between the recognition rate of the neural network and the firing portion of the neuron models in the intermediate layer when the time-integrated loss term γ₂V of the membrane potential is used. The line L512 represents an example of the relationship between the recognition rate of the neural network and the firing proportion of the neuron models in the intermediate layer when the loss term γ₃Q is used.

In the example of FIG. 9, in each case where the time-integrated loss term γ₂V of the membrane potential was used, and the loss term γ₃Q relating to the firing condition was used, a recognition rate in a range of 87.00% to 88.00% was obtained in a firing proportion interval from 0.1 to 0.3. In this way, it was possible to approximately maintain the recognition accuracy of the neural network and reduce the firing proportion.

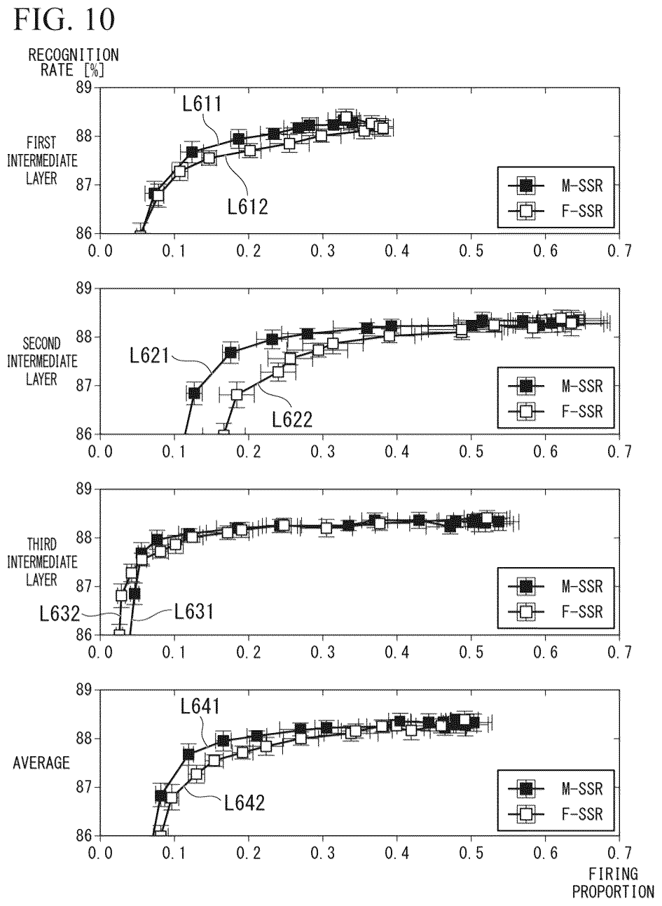

FIG. 10 is a diagram showing a fourth example of a relationship between the recognition rate of a neural network and the firing proportion of the neuron models in the intermediate layers. FIG. 10 shows an example in which a five-layer spiking neural network is used and Fashion-MNIST is used as training data.

The horizontal axis of the graph in FIG. 10 represents the firing proportion. The vertical axis represents the recognition rate. FIG. 10 shows the relationship between the firing proportion and the recognition rate for each of the first intermediate layer, the second intermediate layer, and the third intermediate layer, and an average value of the firing proportion of the neuron models in each of the three intermediate layers.

The line L611 represents an example of the relationship between the recognition rate of the neural network and the firing proportion of the neuron models in the first intermediate layer when the time-integrated loss term γ₂V of the membrane potential is used. The line L612 represents an example of the relationship between the recognition rate of the neural network and the firing proportion of the neuron models in the first intermediate layer when the loss term γ₃Q is used.

The line L621 represents an example of the relationship between the recognition rate of the neural network and the firing proportion of the neuron models in the second intermediate layer when the time-integrated loss term γ₂V of the membrane potential is used. The line L622 represents an example of the relationship between the recognition rate of the neural network and the firing proportion of the neuron models in the second intermediate layer when the loss term γ₃Q is used.

The line L631 represents an example of the relationship between the recognition rate of the neural network and the firing proportion of the neuron models in the third intermediate layer when the time-integrated loss term γ₂V of the membrane potential is used. The line L632 represents an example of the relationship between the recognition rate of the neural network and the firing proportion of the neuron models in the third intermediate layer when the loss term γ₃Q is used.

The line L641 represents an example of the relationship between the recognition rate of the neural network and the average value of the firing proportion of the neuron models in the first intermediate layer to the third intermediate layer when the time-integrated loss term γ₂V of the membrane potential is used. The line L642 represents an example of the relationship between the recognition rate of the neural network and the average value of the firing proportion of the neuron models in the first intermediate layer to the third intermediate layer when the loss term γ₃Q is used.

In the example of FIG. 10, in each case where the time-integrated loss term γ₂V of the membrane potential was used, and the loss term γ₃Q relating to the firing condition was used, and for each of the first intermediate layer, the second intermediate layer, and the third intermediate layer, a recognition rate in a range of about 87% to 89% was obtained when the firing proportion was 0.2 or more. In this way, it was possible to approximately maintain the recognition accuracy of the neural network and reduce the firing proportion.

As described above, the spiking neural network 110 is a time-based spiking neural network that is configured using neuron models based on an integrate-and-fire model. The learning unit 120 teaches the spiking neural network using an evaluation function that indicates a better evaluation as a probability that an individual neuron model fires decreases.

As a result, in the neural network system 100, it is possible to train the spiking neural network 110 such that the firing of the neuron models is suppressed. In this respect, it is expected that the power consumption when the spiking neural network 110 operates will be relatively low.

Furthermore, the learning unit 120 trains the spiking neural network using the loss function C including the sub-expression V that represents the time-integrated loss of the membrane potential. The loss function C including the sub-expression V representing the time-integrated loss of the membrane potential corresponds to an example of an evaluation function that indicates a better evaluation as the value of the time integral relating to the membrane potential of the neuron model decreases.

As a result, in the neural network system 100, it is possible to train the spiking neural network 110 such that the firing of the neuron models is suppressed. In this respect, it is expected that the power consumption when the spiking neural network 110 operates will be relatively low.

Furthermore, the learning unit 120 trains the spiking neural network using the loss function C including the sub-expression V. which represents, for a neuron model that has fired, a total value obtained by dividing an integral of the difference between the membrane potential v^{(l)}ᵢ(t) and the constant v∧ during the time the membrane potential v^{(l)}ᵢ(t) of the neuron model is greater than or equal to the constant v∧, being a value smaller than the threshold membrane potential Vₜₕ, and less than or equal to the threshold membrane potential Vₜₕ, by the difference between the threshold membrane potential Vₜₕ and the constant v∧.

Here, when the value of the membrane potential v^{(l)}ᵢ(t) is greater than or equal to the value of the constant v∧, the value of the membrane potential v^{(l)}ᵢ(t) can be regarded as being relatively close to the value of the threshold membrane potential Vₜₕ, and the probability of the neuron model firing can be evaluated to be relatively high. As the value of the integral of the difference between the membrane potential v^{(l)}ᵢ(t) and the constant v∧ during the time the membrane potential v^{(l)}ᵢ(t) is greater than or equal to the constant v∧, being a value smaller than the threshold membrane potential Vₜₕ, and less than or equal to the threshold membrane potential Vₜₕ, increases, the time during which the value of the membrane potential v^{(l)}ᵢ(t) is greater than or equal to the value of the constant v∧ can interpreted to be longer, or the value of the membrane potential v^{(l)}ᵢ(t) can be interpreted to have become closer to the value of the threshold membrane potential Vₜₕ, or both. The learning unit 120 can use the value of the integral to evaluate the probability that the neuron model will fire.

Furthermore, as the value of the constant v∧ approaches the value of the membrane potential v^{(l)}ⱼ(t), the value of the integral described above decreases. As a result of the learning unit 120 using the value obtained by dividing the value of the integral by the difference between the threshold membrane potential Vₜₕ and the constant v∧, it is expected that the probability of the neuron model firing can be appropriately evaluated, even when the value of the constant v∧ is close to the value of the membrane potential v^{(l)}ᵢ(t).

Moreover, the learning unit 120 trains the spiking neural network using a learning method that uses the evaluation function that takes a limit that brings the constant v∧ close to the threshold membrane potential Vₜₕ, and takes a derivative of the evaluation function.

As a result, as shown in the example of expressions (5) and (6) above, the sub-expression V^{(l)}ᵢ can be simplified, and the calculation load when the learning unit 120 differentiates the loss function C can be reduced.

Also, the learning unit 120 trains the spiking neural network 110 using the loss function C obtained by representing the membrane potential v^{(l)}ᵢ(t) of the neuron model using the weighting coefficients Σ_{j∈r(l)i} w^{(l)}ᵢⱼ of the spikes that have been input to the neuron model, and the firing times of the neuron models that have output the spikes to the neuron model.

As a result, as shown in the example of expression (13), the example of expression (23), and the example of expression (40), the sub-expression V^{(l)}ᵢ can be made sub-expressions in which the membrane potential does not explicitly appear, and the loss function C can be made a loss function in which the membrane potential does not explicitly appear.

According to the neural network system 100, the need to provide a mechanism that measures the value of the membrane potential for each neuron model is eliminated, even when the value of the membrane potential is represented by an analog value such as a current value or a voltage value. In this respect, the burden on the hardware configuration can be reduced.

Furthermore, the learning unit 120 performs differentiation of the loss function C by treating the time interval [t∧^{(l)}ᵢ, t^{(l)}ᵢ] from the time at which the membrane potential v^{(l)}ᵢ(t) has reached the constant v∧ to the firing time t^{(l)}ᵢ of the neuron model whose probability of firing is subjected to evaluation, as a fixed time interval.

As a result, the calculation of the derivative by the learning unit 120 can be simplified, and in this respect, the calculation load on the learning unit 120 can be reduced.

In addition, the learning unit 120 trains the spiking neural network 110 using the loss function C that includes the sub-expression Q that, for a neuron model that has fired, indicates a better evaluation as a total value of the weighting coefficients of the spikes that have been input to the neuron model decreases.

As a result, in the neural network system 100, it is possible to train the spiking neural network 110 such that the firing of the neuron models is suppressed. In this respect, it is expected that the power consumption when the spiking neural network 110 operates will be relatively low.

Furthermore, the learning unit 120 trains the spiking neural network 110 using the loss function C including; the sub-expression ΣₚκₚInSₚ that indicates a better evaluation as the accuracy of estimation by the spiking neural network 110 improves, the sub-expressions V and Q that indicate a better evaluation as a probability that an individual neuron model fires decreases, and the coefficients γ₂ and γ₃ for adjusting the degree of influence of the sub-expressions V and Q that indicate a better evaluation as a probability that an individual neuron model fires decreases.

As a result, in the neural network system 100, a trade-off between the accuracy of estimation by the spiking neural network 110 and the power consumption of the spiking neural network 110 can be adjusted by the simple processing of adjusting the values of the coefficients γ₂ and γ₃.

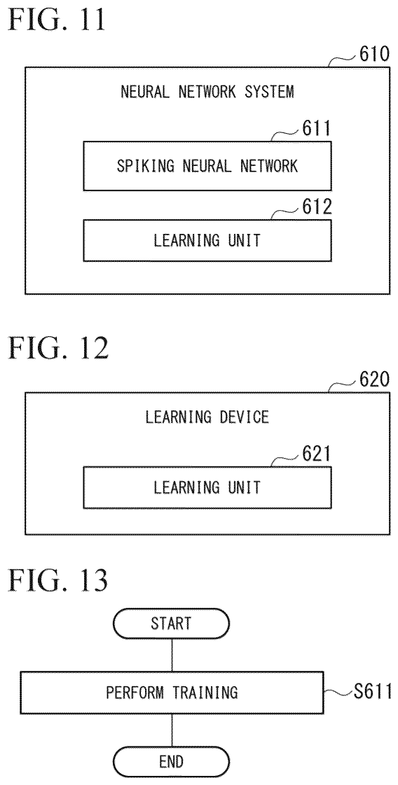

FIG. 11 is a diagram showing an example of a configuration of a neural network system according to an exemplary embodiment. In the configuration shown in FIG. 11, the neural network system 610 includes a spiking neural network 611 and a learning unit 612.

In such a configuration, the spiking neural network 611 is a time-based spiking neural network that is configured using neuron models based on an integrate-and-fire model. The learning unit 612 teaches the spiking neural network using an evaluation function that indicates a better evaluation as a probability that an individual neuron model fires decreases.

The learning unit 612 corresponds to an example of a learning means.

As a result, in the neural network system 610, it is possible to train the spiking neural network 611 such that the firing of the neuron models is suppressed. In this respect, it is expected that the power consumption when the spiking neural network 611 operates will be relatively low.

FIG. 12 is a diagram showing an example of a configuration of a learning device according to an exemplary embodiment. In the configuration shown in FIG. 12, the learning device 620 includes a learning unit 621.

In such a configuration, the learning unit 621 trains a spiking neural network, being a time-based spiking neural network configured using a neuron model based on an integrate-and-fire model, using an evaluation function that indicates a better evaluation as a probability that an individual neuron model fires decreases.

The learning unit 621 corresponds to an example of a learning means.

According to the learning device 620, it is possible to train the spiking neural network such that the firing of the neuron models is suppressed. In this respect, it is expected that the power consumption when the spiking neural network operates will be relatively low.

FIG. 13 is a diagram showing an example of a processing procedure of a learning method according to an exemplary embodiment. In the processing shown in FIG. 13, the learning method includes a training step (step S611).

In the training step (S611), a computer trains a spiking neural network, being a time-based spiking neural network configured using a neuron model based on an integrate-and-fire model, using an evaluation function that indicates a better evaluation as a probability that an individual neuron model fires decreases.

According to the learning method shown in FIG. 13, it is possible to train the spiking neural network such that the firing of the neuron models is suppressed. In this respect, it is expected that the power consumption when the spiking neural network operates will be relatively low.

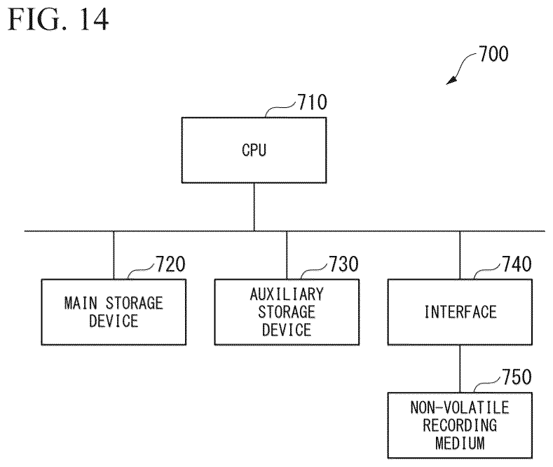

FIG. 14 is a diagram showing a configuration of a computer according to at least one exemplary embodiment. In the configuration shown in FIG. 14, a computer 700 includes a CPU 710, a main storage device 720, an auxiliary storage device 730, an interface 740, and a non-volatile recording medium 750.

Any one or more of the neural network system 100, the neural network system 610, and the learning device 620, or a part thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Further, the CPU 710 secures a storage area corresponding to each of the storage units in the main storage device 720 according to the program. The communication of each device with other devices is executed as a result of the interface 740 having a communication function and performing communication according to the control of the CPU 710. Furthermore, the interface 740 includes a port for the non-volatile recording medium 750, and reads information from the non-volatile recording medium 750 and writes information to the non-volatile recording medium 750.

When the neural network system 100 is implemented by the computer 700, the operation of the spiking neural network 110 and the learning unit 120 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area for the neural network system 100 to perform processing in the main storage device 720 according to the program.

The communication between the neural network system 100 and other devices is executed as a result of the interface 740 including a communication function and operating under the control of the CPU 710. The interactions between the neural network system 100 and the user is executed as a result of the interface 740 having an input device and an output device, presenting information to the user through the output device under the control of the CPU 710, and accepting user operations through the input device.

In addition, the spiking neural network 110 may be configured using an ASIC (application specific integrated circuit), an FPGA (field programmable gate array), a circuit using an analog device, or a combination of these. In this case, the spiking neural network 110 may be configured as a portion of the interface 740, and operate under the control of the CPU 710.

Alternatively, the spiking neural network 110 may be configured as a device or system that is separate to the computer 700, and operate according to a program for the spiking neural network 110. In this case, the spiking neural network 110 may communicate with the computer 700.

Alternatively, both the spiking neural network 110 and the learning unit 120 may be configured using hardware including an ASIC or an FPGA, and operate according to a program for the spiking neural network 110.

When the neural network system 610 is implemented by the computer 700, the operation of the spiking neural network 611 and the learning unit 612 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area for the neural network system 610 to perform processing in the main storage device 720 according to the program.

The communication between the neural network system 610 and other devices is executed as a result of the interface 740 including a communication function and operating under the control of the CPU 710. The interactions between the neural network system 610 and the user is executed as a result of the interface 740 having an input device and an output device, presenting information to the user through the output device under the control of the CPU 710, and accepting user operations through the input device.

In addition, the spiking neural network 611 may be configured using an ASIC (application specific integrated circuit), an FPGA (field programmable gate array), a circuit using an analog device, or a combination of these. In this case, the spiking neural network 611 may be configured as a portion of the interface 740, and operate under the control of the CPU 710.

Alternatively, the spiking neural network 611 may be configured as a device or system that is separate to the computer 700, and operate according to a program for the spiking neural network 611. In this case, the spiking neural network 611 may communicate with the computer 700.

Alternatively, both the spiking neural network 611 and the learning unit 612 may be configured using hardware including an ASIC or an FPGA, and operate according to a program for the spiking neural network 110.

When the learning device 620 is implemented by the computer 700, the operation of the learning unit 621 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the learning device 620 to perform processing according to the program.

The communication between the learning device 620 and other devices is executed as a result of the interface 740 including a communication function and operating under the control of the CPU 710. The interactions between the learning device 620 and the user is executed as a result of the interface 740 having an input device and an output device, presenting information to the user through the output device under the control of the CPU 710, and accepting user operations through the input device.

One or more of the programs described above may be recorded in the non volatile recording medium 750. In this case, the interface 740 may read out the program from the non-volatile recording medium 750. Then, the CPU 710 directly executes the program that has been read out by the interface 740, or executes the program after temporarily saving it in the main storage device 720 or the auxiliary storage device 730.

A program for executing some or all of the processing performed by the neural network system 100, the neural network system 610, and the learning device 620 may be recorded in a computer-readable recording medium, and the processing of each unit may be performed by a computer system reading and executing the program recorded on the recording medium. The “computer system” referred to here is assumed to include an OS and hardware such as a peripheral device.

Furthermore, the “computer-readable recording medium” refers to a portable medium such as a flexible disk, a magnetic optical disk, a ROM (Read Only Memory), or a CD-ROM (Compact Disc Read Only Memory), or a storage device such as a hard disk built into a computer system. Moreover, the program may be one capable of realizing some of the functions described above. Further, the functions described above may be realized in combination with a program already recorded in the computer system.

An exemplary embodiment of the present disclosure has been described in detail above with reference to the drawings. However, specific configurations are in no way limited to the exemplary embodiment, and include designs and the like within a scope not departing from the spirit of the present disclosure.

The whole or part of the exemplary embodiment above can be described as the supplementary notes below, but the exemplary embodiment is not limited thereto.

While preferred embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

### (Supplementary Note 1)

A neural network system comprising: a time-based spiking neural network configured using a neuron model based on an integrate-and-fire model; and a learning means that trains the spiking neural network using an evaluation function that indicates a better evaluation as a probability that an individual neuron model fires decreases.

### (Supplementary Note 2)

The neural network system according to supplementary note 1, wherein the learning means trains the spiking neural network using the evaluation function that indicates a better evaluation as a value of a time integral relating to a membrane potential of the neuron model decreases.

### (Supplementary Note 3)

The neural network system according to supplementary note 2, wherein the learning means trains the spiking neural network using the evaluation function that, includes a sub-expression representing, for a neuron model that has fired, a total value obtained by dividing an integral of a difference between a membrane potential and a set value during a time the membrane potential of the neuron model is greater than or equal to the set value, which is a smaller value than a threshold membrane potential, and less than or equal to the threshold membrane potential, by a difference between the threshold membrane potential and the set value.

### (Supplementary Note 4)

The neural network system according to supplementary note 3, wherein the learning means trains the spiking neural network using a learning method that uses the evaluation function that takes a limit that brings the set value close to the threshold membrane potential, and takes a derivative of the evaluation function.

### (Supplementary Note 5)

The neural network system according to supplementary note 4, wherein the learning means trains the spiking neural network using the evaluation function obtained by representing a membrane potential of the neuron model using a weighting coefficient of a spike that has been input to the neuron model, and a firing time of a neuron model that has output a spike to the neuron model.

### (Supplementary Note 6)

The neural network system according to supplementary notes 4 or 5, wherein the learning means performs differentiation of the evaluation function by treating a time interval from a time at which the membrane potential has reached the set value to a firing time of the neuron model whose probability of firing is subjected to evaluation, as a fixed time interval.

### (Supplementary Note 7)

The neural network system according to any one of supplementary notes 1 to 6, wherein the learning means trains the spiking neural network using the evaluation function that, for a neuron model that has fired, indicates a better evaluation as a total value of the weighting coefficients of the spikes that have been input to the neuron model decreases.

### (Supplementary Note 8)

The neural network system according to any one of supplementary notes 1 to 7, wherein the learning means trains the spiking neural network using the evaluation function including; a sub-expression that indicates a better evaluation as an accuracy of estimation by the spiking neural network increases, a sub-expression that indicates a better evaluation as a probability that an individual neuron model fires decreases, and a coefficient for adjusting a degree of influence of a sub-expression that indicates a better evaluation as a probability that an individual neuron model fires decreases.

### (Supplementary Note 9)

A learning device comprising: a learning means that trains a spiking neural network, being a time-based spiking neural network configured using a neuron model based on an integrate-and-fire model, using an evaluation function that indicates a better evaluation as a probability that an individual neuron model fires decreases.

### (Supplementary Note 10)

A learning method in which a computer performs the step of: performing learning of a spiking neural network, being a time-based spiking neural network configured using a neuron model based on an integrate-and-fire model, using an evaluation function that indicates a better evaluation as a probability that an individual neuron model fires decreases.

### (Supplementary Note 11)

A program for causing a computer to execute the step of: performing learning of a spiking neural network, being a time-based spiking neural network configured using a neuron model based on an integrate-and-fire model, using an evaluation function that indicates a better evaluation as a probability that an individual neuron model fires decreases.

What is claimed is:

1. A neural network system comprising:
a time-based spiking neural network configured using a neuron model based on an integrate-and-fire model;
at least one memory configured to store instructions; and
at least one processor configured to execute the instructions to:
train the spiking neural network using an evaluation function that indicates a better evaluation as a probability that an individual neuron model fires decreases.

2. The neural network system according to claim 1, wherein the at least one processor is configured to train the spiking neural network using the evaluation function that indicates a better evaluation as a value of a time integral relating to a membrane potential of the neuron model decreases.

3. The neural network system according to claim 2, wherein the at least one processor is configured to train the spiking neural network using the evaluation function that includes a sub-expression representing, for a neuron model that has fired, a total value obtained by dividing an integral of a difference between a membrane potential and a set value during a time the membrane potential of the neuron model is greater than or equal to the set value, being a smaller value than a threshold membrane potential, and less than or equal to the threshold membrane potential, by a difference between the threshold membrane potential and the set value.

4. The neural network system according to claim 3, wherein the at least one processor is configured to train the spiking neural network using a learning method that uses the evaluation function that takes a limit that brings the set value close to the threshold membrane potential, and takes a derivative of the evaluation function.

5. The neural network system according to claim 4, wherein the at least one processor is configured to train the spiking neural network using the evaluation function obtained by representing a membrane potential of the neuron model using a weighting coefficient of a spike that has been input to the neuron model, and a firing time of a neuron model that has output a spike to the neuron model.

6. The neural network system according to claim 4, wherein the at least one processor is configured to perform differentiation of the evaluation function by treating a time interval from a time at which the membrane potential has reached the set value to a firing time of the neuron model, as a fixed time interval.

7. The neural network system according to claim 1, wherein the at least one processor is configured to train the spiking neural network using the evaluation function that, for a neuron model that has fired, indicates a better evaluation as a total value of weighting coefficients of spikes that have been input to the neuron model decreases.

8. A learning device comprising:
at least one memory configured to store instructions; and
at least one processor configured to execute the instructions to:
train a spiking neural network, being a time-based spiking neural network configured using a neuron model based on an integrate-and-fire model, using an evaluation function that indicates a better evaluation as a probability that an individual neuron model fires decreases.

9. A learning method executed by a computer, the learning method comprising:
performing learning of a spiking neural network, being a time-based spiking neural network configured using a neuron model based on an integrate-and-fire model, using an evaluation function that indicates a better evaluation as a probability that an individual neuron model fires decreases.
